(19) United States
(12) Patent Application Publication
(10) Pub. No.: US 2015/0234219 A1
(43) Pub. Date: Aug. 20, 2015

(54) METHOD OF PASSIVATING A CONDUCTIVE PATTERN WITH SELF-ASSEMBLING MONOLAYERS

(71) Applicant: Uni-Pixel Displays, Inc., The Woodlands, TX (US)

(72) Inventor: Robert J. Petcavich, The Woodlands, TX (US)

(73) Assignee: Uni-Pixel Displays, Inc., The Woodlands, TX (US)

(21) Appl. No.: 14/183,623

(22) Filed: Feb. 19, 2014

(51) Int. Cl. G02F 1/1333; G06F 3/0488

(52) U.S. Cl. CPC G02F 1/13338; G06F 3/0488

(57) ABSTRACT

A method includes disposing a conductive pattern on a substrate. Self-assembling monolayers are applied to exposed portions of the conductive pattern. The self-assembling monolayers self-organize and bond to the exposed portions of the conductive pattern. The substrate is cleaned.

### BACKGROUND OF THE INVENTION

A touch screen enabled system allows a user to control various aspects of the system by touch or gestures. For example, a user may interact directly with objects depicted on a display device by touch or gestures that are sensed by a touch sensor. The touch sensor typically includes a pattern of conductive lines disposed on a substrate configured to sense touch.

Touch screens are commonly found in consumer systems, commercial systems, and industrial systems including, but not limited to, smartphones, tablet computers, laptop computers, desktop computers, printers, monitors, televisions, appliances, kiosks, copiers, desktop phones, automotive display systems, portable gaming devices, and gaming consoles.

### BRIEF SUMMARY OF THE INVENTION

According to one aspect of one or more embodiments of the present invention, a method includes disposing a conductive pattern on a substrate. Self-assembling monolayers are applied to exposed portions of the conductive pattern. The self-assembling monolayers self-organize and bond to the exposed portions of the conductive pattern. The substrate is cleaned.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled computing system in accordance with one or more embodiments of the present invention.

FIG. 3 shows a functional representation of a touch sensor as part of a touch screen in accordance with one or more embodiments of the present invention.

FIG. 4A shows a cross-section of a touch sensor with conductive patterns disposed on opposing sides of a transparent substrate in accordance with one or more embodiments of the present invention.

FIG. 4B shows a cross-section of a touch sensor with a first conductive pattern disposed on a first transparent substrate and a second conductive pattern disposed on a second transparent substrate in accordance with one or more embodiments of the present invention.

FIG. 4C shows a cross-section of a touch sensor with a first conductive pattern disposed on a first transparent substrate and a second conductive pattern disposed on a second transparent substrate in accordance with one or more embodiments of the present invention.

FIG. 4D shows a cross-section of a touch sensor with a first conductive pattern disposed on a first transparent substrate and a second conductive pattern disposed on a second transparent substrate in accordance with one or more embodiments of the present invention.

FIG. 5 shows a first conductive pattern disposed on a transparent substrate in accordance with one or more embodiments of the present invention.

FIG. 6 shows a second conductive pattern disposed on a transparent substrate in accordance with one or more embodiments of the present invention.

FIG. 7 shows a portion of a touch sensor in accordance with one or more embodiments of the present invention.

FIG. 8 shows a method of passivating a conductive pattern with self-assembling monolayers in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

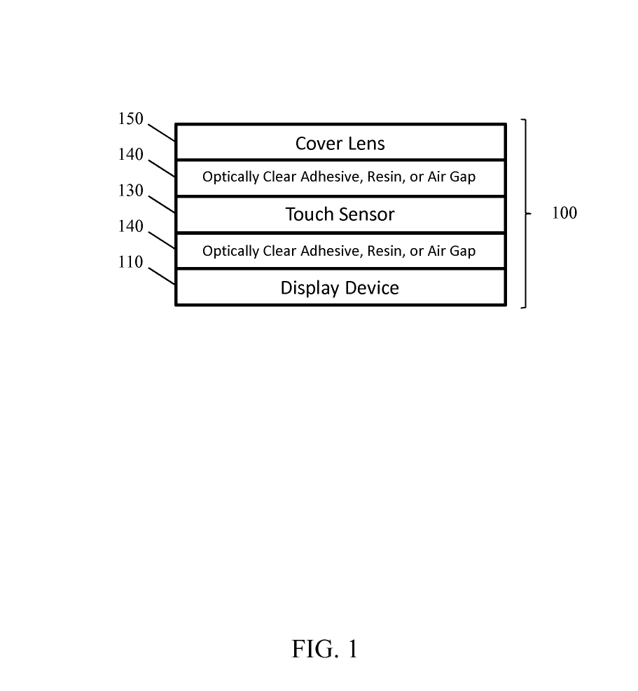

FIG. 1 shows a cross-section of a touch screen 100 in accordance with one or more embodiments of the present invention. Touch screen 100 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, a touch sensor 130 may overlay display device 110. In certain embodiments, an optically clear adhesive or resin 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110. A cover lens 150 may overlay touch sensor 130. Cover lens 150 may be composed of glass, plastic, film, or other material. In certain embodiments, an optically clear adhesive or resin 140 may bond a bottom side of cover lens 150 to a top, or user-facing, side of touch sensor 130. In other embodiments, an isolation layer, or air gap, 140 may separate the bottom side of cover lens 150 and the top, or user-facing, side of touch sensor 130. A top side of cover lens 150 faces the user and protects the underlying components of touch screen 100. One of ordinary skill in the art will recognize that other embodiments, including those where a touch sensor is integrated into the display device 110 stack, may be used in accordance with one or more embodiments of the present invention.

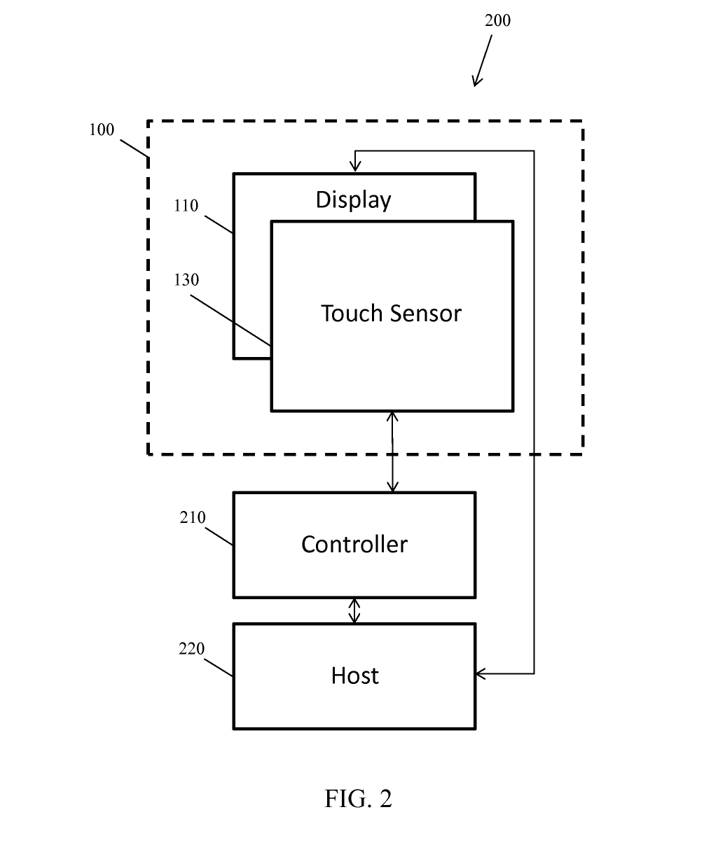

FIG. 2 shows a schematic view of a touch screen enabled computing system 200 in accordance with one or more embodiments of the present invention. Computing system 200 may be a consumer computing system, commercial computing system, or industrial computing system including, but not limited to, smartphones, tablet computers, laptop computers, desktop computers, printers, monitors, televisions, appliances, kiosks, automatic teller machines, copiers, desktop phones, automotive display systems, portable gaming devices, gaming consoles, or other applications or designs suitable for use with touch screen 100.

Computing system 200 may include one or more printed or flex circuits (not shown) on which one or more processors (not shown) and system memory (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). Computing system 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including network attached storage devices and cloud-based storage devices.

In certain embodiments, touch screen 100 may include display device 110 and touch sensor 130 that overlays at least a portion of a viewable area of display device 110. In other embodiments, touch sensor 130 may be integrated into display device 110. Controller 210 electrically drives at least a portion of touch sensor 130. Touch sensor 130 senses touch (capacitance, resistance, optical, or acoustic) and conveys information corresponding to the sensed touch to controller 210. In typical applications, the manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with computing system 200 by touch or gestures on touch screen 100. In certain embodiments, host 220 may be the one or more printed or flex circuits (not shown) on which the one or more processors (not shown) are disposed. In other embodiments, host 220 may be a subsystem or any other part of computing system 200 that is configured to interface with display device 110 and controller 210.

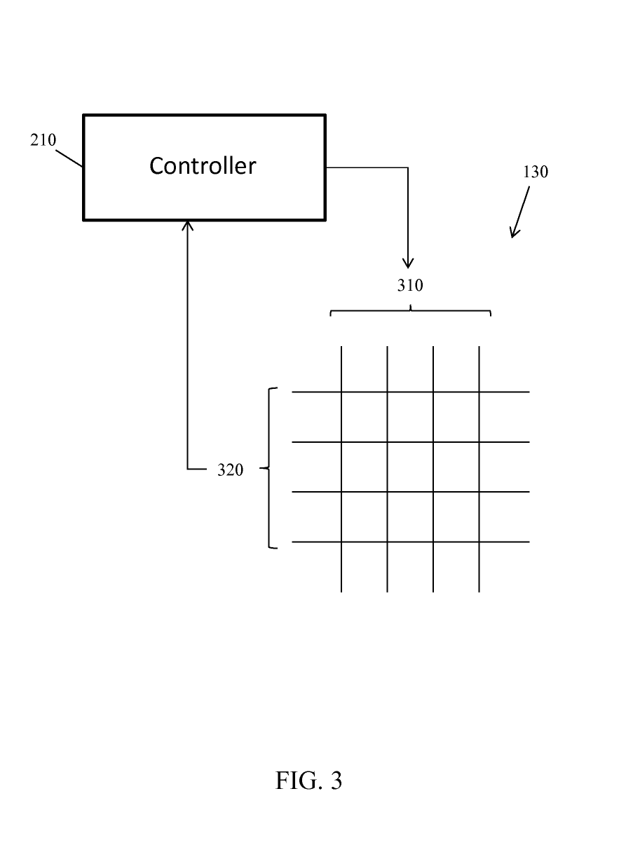

FIG. 3 shows a functional representation of a touch sensor 130 as part of a touch screen 100 in accordance with one or more embodiments of the present invention. In certain embodiments, touch sensor 130 may be viewed as a plurality of column lines 310 and a plurality of row lines 320 arranged as a mesh grid. The number of column lines 310 and the number of row lines 320 may not be the same and may vary based on an application or a design. The apparent intersection of column lines 310 and row lines 320 may be viewed as uniquely addressable locations of touch sensor 130. In operation, controller 210 may electrically drive one or more row lines 320 and touch sensor 130 may sense touch on one or more column lines 310 sampled by controller 210. One of ordinary skill in the art will recognize that the role of column lines 310 and row lines 320 may be reversed such that controller 210 electrically drives one or more column lines 310 and touch sensor 130 senses touch on one or more row lines 320 sampled by controller 210.

In certain embodiments, controller 210 may interface with touch sensor 130 by a scanning process. In such an embodiment, controller 210 may electrically drive a selected row line 320 (or column line 310) and sample all column lines 310 (or row lines 32) that intersect the selected row line 320 (or the selected column line 310) by measuring, for example, capacitance at each intersection. This process may be continued through all row lines 320 (or all column lines 310) such that capacitance is measured at each uniquely addressable location of touch sensor 130 at predetermined intervals. Controller 210 may allow for the adjustment of the scan rate depending on the needs of a particular design or application. One of ordinary skill in the art will recognize that the scanning process discussed above may also be used with other touch sensor technologies, applications, or designs in accordance with one or more embodiments of the present invention.

In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

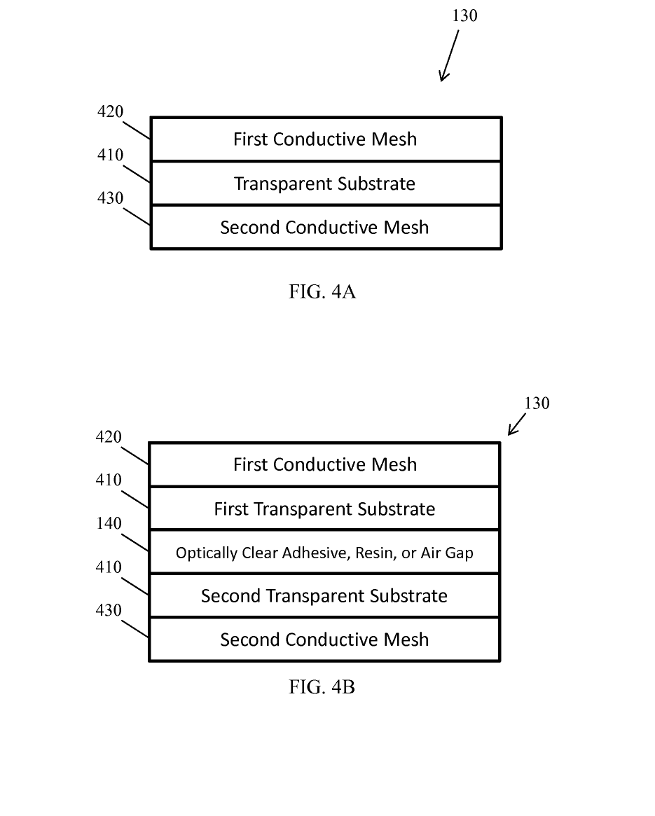

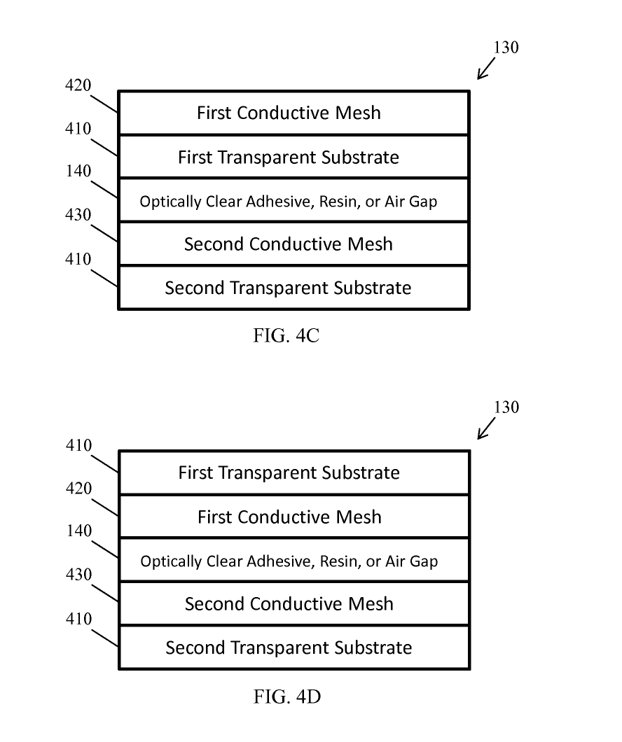

FIG. 4A shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410.

FIG. 4B shows a cross-section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on the top, or user-facing, side of first transparent substrate 410 and second conductive pattern 430 disposed on the bottom side of second transparent substrate 410. A bottom side of the first transparent substrate 410 may overlay a top side of the second transparent substrate 410 at a predetermined alignment. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 between the bottom side of the first transparent substrate 410 and the top side of the second transparent substrate 410.

FIG. 4C shows a cross-section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on the top, or user-facing, side of the first transparent substrate 410 and second conductive pattern 430 disposed on the top side of the second transparent substrate 410. A bottom side of the first transparent substrate 410 may overlay the second conductive pattern 430 disposed on the top side of the second transparent substrate 410 at a predetermined alignment. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 between the bottom side of the first transparent substrate 410 and the second conductive pattern 430 disposed on the top side of the second transparent substrate 410.

FIG. 4D shows a cross-section of a touch sensor 130 with a first conductive pattern 420 disposed on a first transparent substrate 410 and a second conductive pattern 430 disposed on a second transparent substrate 410 in accordance with one or more embodiments of the present invention. In certain embodiments, touch sensor 130 may include first conductive pattern 420 disposed on the bottom side of the first transparent substrate 410 and second conductive pattern 430 disposed on the top side of the second transparent substrate 410. The first conductive pattern 420 disposed on the bottom side of the first transparent substrate 410 may overlay the second conductive pattern 430 disposed on the top side of the second transparent substrate 410 at a predetermined alignment. In certain embodiments, the first transparent substrate 410 may be bonded to the second transparent substrate 410 by a lamination process (not shown). In other embodiments, the first transparent substrate 410 may be bonded to the second transparent substrate 410 by an optically clear adhesive or resin 140. In still other embodiments, the first transparent substrate 410 and the second transparent substrate 410 may be secured in place and there may be an isolation layer, or air gap, 140 between the first conductive pattern 420 disposed on the bottom side of the first transparent substrate 410 and the second conductive pattern 430 disposed on the top side of the second transparent substrate 410.

One of ordinary skill in the art will recognize that the disposition of the first conductive pattern 420 and the second conductive pattern 430 may be reversed in accordance with one or more embodiments of the present invention. One of ordinary skill in the art will also recognize that the above-noted embodiments, as well as others, may be used in applications where a touch sensor 130 is integrated into a display device (e.g., display device 110 of FIG. 1 or FIG. 2). As such, one of ordinary skill in the art will recognize that, in addition to the above-noted embodiments, other stackups, including those that vary in the number, type, and organization of substrate(s) and/or conductive pattern(s) are within the scope of one or more embodiments of the present invention.

A conductive pattern (e.g., first conductive pattern 420 or second conductive pattern 430) may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing, including the flexographic printing of a conductive ink and the flexographic printing of a catalytic ink that is metallized by an electroless plating process, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or UV-based photolithography, e-beam/ion-beam lithography, x-ray lithography, interference lithography, scanning probe lithography, imprint lithography, or magneto lithography. One of ordinary skill in the art will recognize that any process suitable for disposing conductive lines or features on substrate may be used in accordance with one or more embodiments of the present invention.

With respect to transparent substrate 410, transparent means the transmission of visible light with a transmittance rate of 85% or more. In certain embodiments, transparent substrate 410 may be polyethylene terephthalate (“PET”), polyethylene naphthalate (“PEN”), cellulose acetate (“TAC”), cycloaliphatic hydrocarbons (“COP”), bi-axially-oriented polypropylene (“BOPP”), polyester, polycarbonate, glass, or combinations thereof. In other embodiments, transparent substrate 410 may be any other transparent material suitable for use as a substrate upon which a conductive pattern may be disposed. One of ordinary skill in the art will recognize that the composition of transparent substrate 410 may vary based on an application or design in accordance with one or more embodiments of the present invention.

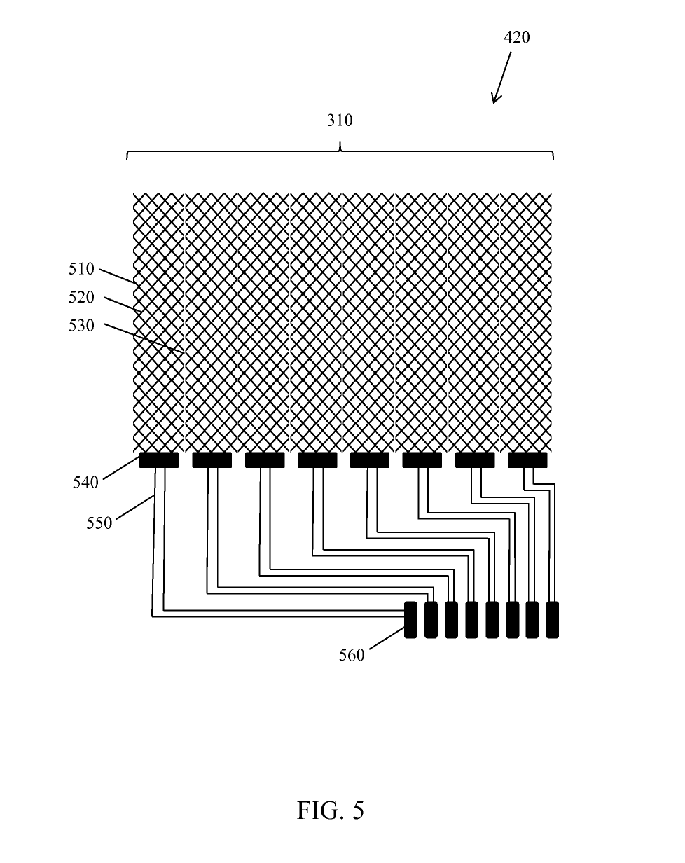

FIG. 5 shows a first conductive pattern 420 disposed on a transparent substrate (e.g., transparent substrate 410) in accordance with one or more embodiments of the present invention. In certain embodiments, first conductive pattern 420 may include a mesh formed by a plurality of parallel conductive lines oriented in a first direction 510 and a plurality of parallel conductive lines oriented in a second direction 520 that are disposed on a side of a transparent substrate (e.g., transparent substrate 410). One of ordinary skill in the art will recognize that a size of first conductive pattern 420 may vary based on an application or a design in accordance with one or more embodiments of the present invention. In other embodiments (not independently illustrated), first conductive pattern 420 may include any other pattern formed by one or more conductive lines or features in any shape or pattern. One of ordinary skill in the art will recognize that the composition and design of a conductive pattern may vary in accordance with one or more embodiments of the present invention. In still other embodiments (not independently illustrated), any other conductive pattern may be used in accordance with one or more embodiments of the present invention. One of ordinary skill in the art will recognize that a conductive pattern is not limited to touch sensor applications and other embodiments may be used in other applications or designs in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention. In other embodiments (not independently illustrated), a conductive pattern may include one or more conductive lines or features in any shape or pattern. One of ordinary skill in the art will also recognize that a conductive pattern is not limited to sets of parallel conductive lines and could be any other shape or pattern, including predetermined or random orientations of line segments, curved line segments, conductive particles, polygons, or any other shape(s) or pattern(s) comprised of electrically conductive material in accordance with one or more embodiments of the present invention.

In certain embodiments, a plurality of breaks 530 may partition first conductive pattern 420 into a plurality of column lines 310, each electrically partitioned from the others. Each column line 310 may route to a channel pad 540. Each channel pad 540 may route to an interface connector 560 by way of one or more interconnect conductive lines 550. Interface connectors 560 may provide a connection interface between the touch sensor (130 of FIG. 1) and the controller (210 of FIG. 2).

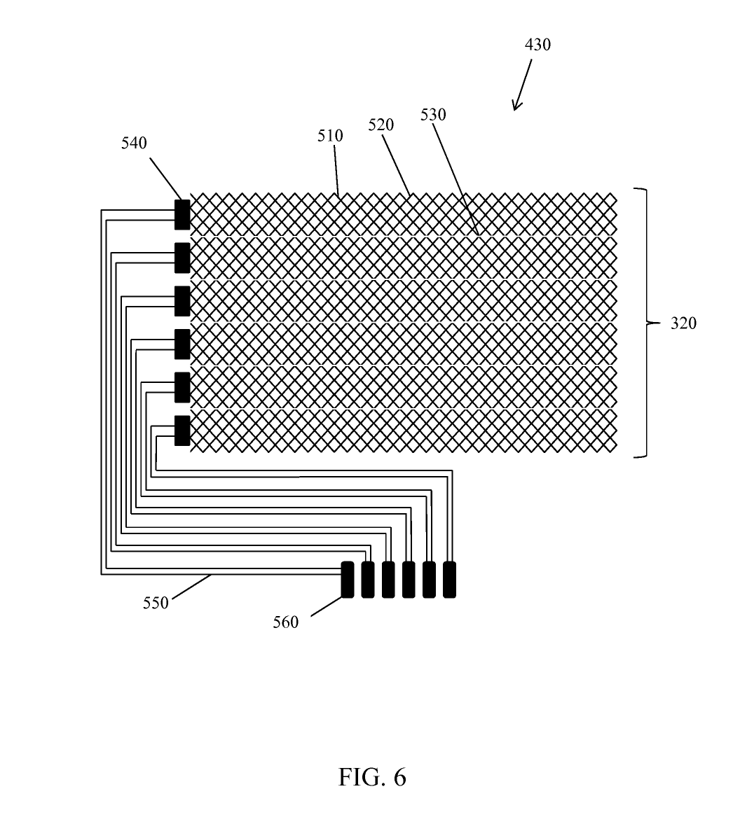

FIG. 6 shows a second conductive pattern 430 disposed on a transparent substrate (e.g., transparent substrate 410) in accordance with one or more embodiments of the present invention. In certain embodiments, second conductive pattern 430 may include a mesh formed by a plurality of parallel conductive lines oriented in a first direction 510 and a plurality of parallel conductive lines oriented in a second direction 520 disposed on a side of a transparent substrate (e.g., transparent substrate 410). One of ordinary skill in the art will recognize that a size of the second conductive pattern 430 may vary based on an application or a design in accordance with one or more embodiments of the present invention. Typically, in touch sensor applications, the second conductive pattern 430 is substantially similar in size to the first conductive pattern 420. In other embodiments (not independently illustrated), second conductive pattern 430 may include any other pattern formed by one or more conductive lines or features in any shape or pattern. One of ordinary skill in the art will recognize that the composition and design of a conductive pattern may vary in accordance with one or more embodiments of the present invention. In still other embodiments (not independently illustrated), any other conductive pattern may be used in accordance with one or more embodiments of the present invention. One of ordinary skill in the art will recognize that a conductive pattern is not limited to touch sensor applications and other embodiments may be used in other applications or designs in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention. In other embodiments (not independently illustrated), a conductive pattern may include one or more conductive lines or features in any shape or pattern. One of ordinary skill in the art will also recognize that a conductive pattern is not limited to sets of parallel conductive lines and could be any other shape or pattern, including predetermined or random orientations of line segments, curved line segments, conductive particles, polygons, or any other shape(s) or pattern(s) comprised of electrically conductive material in accordance with one or more embodiments of the present invention.

In certain embodiments, a plurality of breaks 530 may partition second conductive pattern 430 into a plurality of row lines 320, each electrically partitioned from the others. Each row line 320 may route to a channel pad 540. Each channel pad 540 may route to an interface connector 560 by way of one or more interconnect conductive lines 550. Interface connectors 560 may provide a connection interface between the touch sensor (130 of FIG. 1) and the controller (210 of FIG. 2).

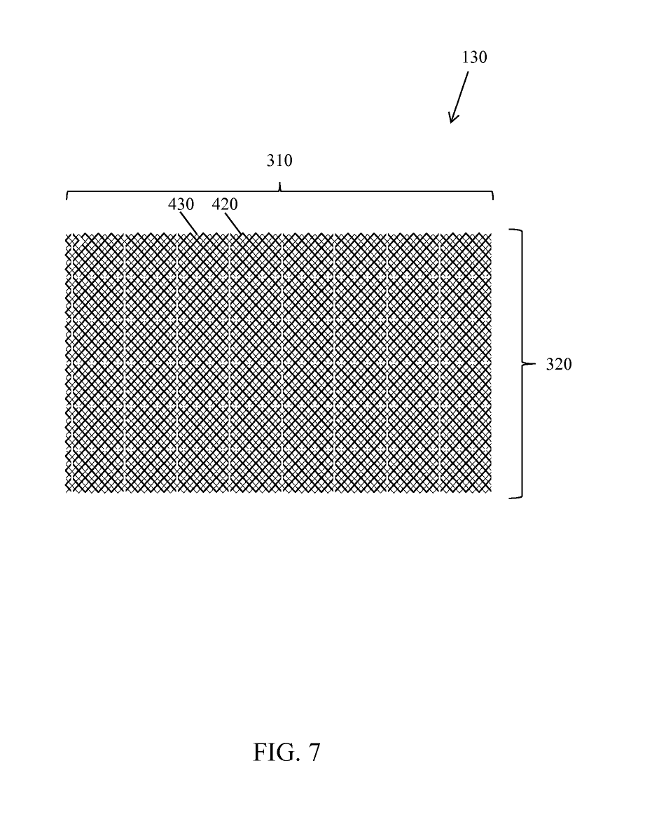

FIG. 7 shows a portion of a touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410) and disposing a second conductive pattern 430 on a side of a second transparent substrate (e.g., transparent substrate 410). One of ordinary skill in the art will recognize that the disposition of the conductive pattern or patterns may vary based on the touch sensor 130 stackup in accordance with one or more embodiments of the present invention. In embodiments that use two conductive patterns, the first conductive pattern 420 and the second conductive pattern 430 may be horizontally and/or vertically offset relative to one another. The predetermined offset between the first conductive pattern 420 and the second conductive pattern 430 may vary based on an application or a design.

In certain embodiments, the first conductive pattern 420 may include a plurality of parallel conductive lines oriented in a first direction (510 of FIG. 5) and a plurality of parallel conductive lines oriented in a second direction (520 of FIG. 5) that form a mesh that is partitioned by a plurality of breaks (530 of FIG. 5) into electrically partitioned column lines 310. The second conductive pattern 430 may include a plurality of parallel conductive lines oriented in a first direction (510 of FIG. 6) and a plurality of parallel conductive lines oriented in a second direction (520 of FIG. 6) that form a mesh that is partitioned by a plurality of breaks (530 of FIG. 6) into electrically partitioned row lines 320. In operation, a controller (210 of FIG. 2) may electrically drive one or more row lines 320 (or column lines 310) and touch sensor 130 senses touch on one or more column lines 310 (or row lines 320) sampled by the controller (210 of FIG. 2). In other embodiments, the role of the first conductive pattern 420 and the second conductive pattern 430 may be reversed.

In certain embodiments, one or more of the plurality of parallel conductive lines oriented in a first direction (510 of FIG. 5 and FIG. 6), one or more of the plurality of parallel conductive lines oriented in a second direction (520 of FIG. 5 and FIG. 6), one or more of the plurality of breaks (530 of FIG. 5 and FIG. 6), one or more of the plurality of channel pads (540 of FIG. 5 and FIG. 6), one or more of the plurality of interconnect conductive lines (550 of FIG. 5 and FIG. 6), and/or one or more of the plurality of interface connectors (560 of FIG. 5 and FIG. 6) of the first conductive pattern 420 or second conductive pattern 430 may have different line widths and/or different orientations. In addition, the number of parallel conductive lines oriented in the first direction (510 of FIG. 5 and FIG. 6), the number of parallel conductive lines oriented in the second direction (520 of FIG. 5 and FIG. 6), and the line-to-line spacing between them may vary based on an application or a design. One of ordinary skill in the art will recognize that the size, configuration, and design of each conductive pattern may vary in accordance with one or more embodiments of the present invention.

In certain embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width less than approximately 5 micrometers. In other embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width in a range between approximately 5 micrometers and approximately 10 micrometers. In still other embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width in a range between approximately 10 micrometers and approximately 50 micrometers. In still other embodiments, one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may have a line width greater than approximately 50 micrometers. One of ordinary skill in the art will recognize that the shape and width of one or more of the plurality of parallel conductive lines oriented in the first direction (510 of FIG. 5 and FIG. 6) and one or more of the plurality of parallel conductive lines oriented in the second direction (520 of FIG. 5 and FIG. 6) may vary in accordance with one or more embodiments of the present invention.

In certain embodiments, one or more of the plurality of channel pads (540 of FIG. 5 and FIG. 6), one or more of the plurality of interconnect conductive lines (550 of FIG. 5 and FIG. 6), and/or one or more of the plurality of interface connectors (560 of FIG. 5 and FIG. 6) may have a different width or orientation. In addition, the number of channel pads (540 of FIG. 5 and FIG. 6), interconnect conductive lines (550 of FIG. 5 and FIG. 6), and/or interface connectors (560 of FIG. 5 and FIG. 6) and the line-to-line spacing between them may vary based on an application or a design. One of ordinary skill in the art will recognize that the size, configuration, and design of each channel pad (540 of FIG. 5 and FIG. 6), interconnect conductive line (550 of FIG. 5 and FIG. 6), and/or interface connector (560 of FIG. 5 and FIG. 6) may vary in accordance with one or more embodiments of the present invention.

In typical applications, each of the one or more channel pads (540 of FIG. 5 and FIG. 6), interconnect conductive lines (550 of FIG. 5 and FIG. 6), and/or interface connectors (560 of FIG. 5 and FIG. 6) have a width substantially larger than each of the plurality of parallel conductive lines oriented in a first direction (510 of FIG. 5 and FIG. 6) or each of the plurality of parallel conductive lines oriented in a second direction (520 of FIG. 5 and FIG. 6). One of ordinary skill in the art will recognize that the size, configuration, and design as well as the number, shape, and width of channel pads (540 of FIG. 5 and FIG. 6), interconnect conductive lines (550 of FIG. 5 and FIG. 6), and/or interface connectors (560 of FIG. 5 and FIG. 6) may vary based on an application or a design in accordance with one or more embodiments of the present invention.

While conductive patterns 420 and 430 are described in relation to one or more touch sensor embodiments, other conductive patterns may be used in accordance with one or more embodiments of the present invention. One of ordinary skill in the art will recognize that a conductive pattern may include any pattern formed by one or more conductive lines or features in any shape or pattern. One of ordinary skill in the art will also recognize that the composition and design of a conductive pattern may vary based on an application or design, including embodiments that do not implement a touch sensor function, in accordance with one or more embodiments of the present invention.

A conductive pattern may be comprised of any conductive metal, metal alloy, or metal oxide that is conductive and capable of being disposed on a substrate. A conductive pattern is prone to degradation from use and other causes over time. As a consequence, the reliability, functionality, and useable life of the conductive pattern, or a touch sensor in which it may be disposed, may be substantially reduced. Degradation may occur as a result of day-to-day usage, electro-migration, airborne, solution-based, or liquid-based exposure to the environment, and/or exposure to corrosive agents such as soft drinks, coffee, oils, bodily fluids, acids, caustics, atmospheric pollutants, environmental pollutants, salt water, or water with contaminants such as salts, minerals, or ions. In addition to the reduction in reliability and functionality, degradation such as, for example, corrosion may render one or more of the conductive patterns more visually apparent to an end user prior to failure. Corrosion typically renders affected portions of a conductive pattern black, blue, or green. As such, degradation may reduce the quality of use prior to failure.

A passivation agent may be applied to the surface of one or more of the conductive patterns to reduce the rate at which the one or more conductive patterns degrade. A passivation agent may protect the exposed metal, metal alloy, or metal oxide surfaces of the one or more conductive patterns from degradation for a period of time. In certain embodiments, where the one or more conductive patterns comprise copper or copper alloy, a nickel or nickel alloy passivation layer may be used. The process of passivating a conductive pattern with a nickel or nickel alloy passivation layer adds expense, increases manufacturing time, increases manufacturing complexity, and, may increase reflectivity.

For example, one or more of the conductive patterns may comprise copper or copper alloy. The copper or copper alloy may be electroless plated with nickel or nickel alloy, such as nickel boron alloy, through an electroless plating process. The application of the nickel or nickel alloy is expensive, requires additional process steps, and requires dedicated equipment. In addition, the process of passivating copper or copper alloys with nickel or nickel alloys may require additional cleaning steps prior to electroless plating the nickel or nickel alloy and/or after electroless plating the nickel or nickel alloy. Cleaning may be necessary to ensure that exposed portions of the transparent substrate are not coated and are capable of being bonded to other devices or structures as part of an assembly. Once applied, the nickel or nickel alloy passivation layer may increase the reflectivity of the one or more conductive patterns and render it more visually apparent to an end user.

In one or more embodiments of the present invention, a method of passivating a conductive pattern with self-assembling monolayers provides a thin protective layer of self-assembled monolayers that has a thickness of a single molecular layer. The method is compatible with existing processes used to dispose a conductive pattern on substrate, reduces material and manufacturing cost, reduces manufacturing complexity, and provides improved protection from degradation.

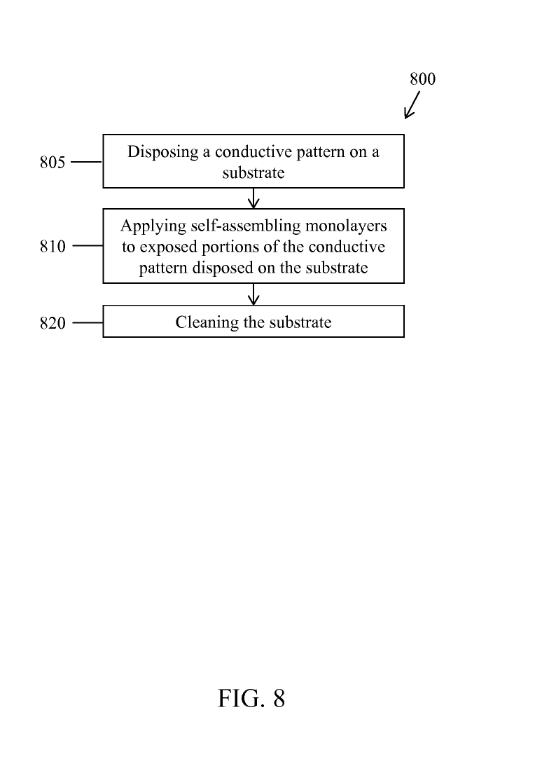

FIG. 8 shows a method 800 of passivating a conductive pattern with self-assembling monolayers in accordance with one or more embodiments of the present invention. In step 805, a conductive pattern may be disposed on a substrate. The conductive pattern disposed on substrate includes a non-exposed portion of the conductive pattern that is in contact with, connected to, or otherwise bonded to, the substrate and one or more exposed portions of the conductive pattern, such as, for example, the portions of the conductive pattern exposed to the environment and subject to degradation.

In step 810, self-assembling monolayers may be applied to exposed portions of the conductive pattern disposed on the substrate. The self-assembling monolayers self-organize and bond only to the exposed portions of the conductive pattern disposed on the substrate. The exposed portions of the conductive pattern include those portions of the conductive pattern that are exposed to the environment and subject to degradation. The self-assembling monolayers do not self-organize or bond to exposed portions of the substrate. The exposed portions of the substrate are those portions of the substrate other than where the conductive pattern is disposed. Advantageously, the exposed portions of the substrate may more easily bond to other devices or structures as part of an assembly. Because the self-assembling monolayers only bond to metal or metal oxides, the application process may be simplified because the entire substrate, including the exposed portions of the conductive pattern, may be covered with self-assembling monolayers during the application process.

In certain embodiments, the exposed portions of the conductive pattern may be spray coated with a solution of self-assembling monolayers. In other embodiments, the exposed portions of the conductive pattern may be dip coated with a solution of self-assembling monolayers. In still other embodiments, the exposed portions of the conductive pattern may be roller coated with a solution of self-assembling monolayers. In still other embodiments, the exposed portions of the conductive pattern may be coated by fogging with an aerosol of self-assembling monolayers. One of ordinary skill in the art will recognize that any suitable method of applying self-assembling monolayers may be used in accordance with one or more embodiments of the present invention. The self-assembling monolayers may be applied at ambient temperature, humidity, and/or atmospheric pressure.

In certain embodiments, the self-assembling monolayers may be organophosphorous compounds such as, for example, organophosphoric acids, organophosphonic acids, and/or organic phosphonic acids, including derivatives. Derivatives may include, for example, materials that perform similarly to acids such as acid salts, acid esters, and acid complexes. The organo group may monomeric or polymeric, including oligomeric. Phosphoric acids may include compounds or a mixture of compounds that exhibit the following chemical structure:

(R″O)ₓP(O)(OR′)_{y}, (1)

where P is phosphorous, O is oxygen, x is an a range between 1 and 2, and y is in a range between 1 and 2 such that the sum, x+y, is equal to 3. R″ may be an organic radical containing fluorine, F, and may be monomeric or polymeric. In certain embodiments, R″ may comprise organic monomeric radicals having a total number of repeating units or atoms in a range between 1 and 30, such as a chain of carbon, C, atoms. The chain may have a length in a range between 6 carbon atoms and 18 carbon atoms. In certain embodiments, the chain may have a length in a range between 7 carbon atoms and 12 carbon atoms. R″ may be aliphatic, aromatic, or both aliphatic and aromatic. R″ may be an unsubstituted hydrocarbon or a substituted hydrocarbon. In certain embodiments, R′ may be hydrogen, H, a metal such as, for example, an alkali metal (e.g., potassium, K, or sodium, Na), or an alkyl having a chain of carbon, C, atoms that have a length in a range between 1 carbon atom and 4 carbon atoms, such as methyl or ethyl. In certain embodiments, at least a portion of R′ may be hydrogen, H.

Monomeric phosphonic acids may include compounds or a mixture of compounds that exhibit the following chemical structure:

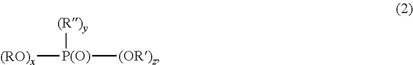

where P is phosphorous, O is oxygen, x is an a range between 1 and 2, y is 1, and z is in a range between 1 and 2 such that the sum, x+y+z, is equal to 3. R″ may be an organic radical containing fluorine, F, and may be monomeric or polymeric. In certain embodiments, R″ may comprise organic monomeric radicals having a total number of repeating units or atoms in a range between 1 and 30, such as a chain of carbon, C, atoms. The chain may have a length in a range between 6 carbon atoms and 18 carbon atoms. In certain embodiments, the chain may have a length in a range between 7 carbon atoms and 12 carbon atoms. R″ may be an unsubstituted hydrocarbon or a substituted hydrocarbon. In certain embodiments, R′ and R may be hydrogen, H, a metal such as, for example, an alkali metal (e.g., potassium, K, or sodium, Na), an alkyl having a chain of carbon, C, atoms that have a length in a range between 1 carbon atom and 4 carbon atoms, such as methyl or ethyl, or a base such as an amine. In certain embodiments, at least a portion of R′ and R may be hydrogen, H. R may be aliphatic, aromatic, or both aliphatic and aromatic.

Monomeric phosphonic acids may include compounds or a mixture of compounds that exhibit the following chemical structure:

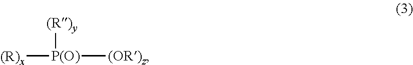

where P is phosphorous, O is oxygen, x is an a range between 0 and 2, y is in a range between 0 and 2, and z is 1 such that the sum, x+y+z, is equal to 3. R and R″ may be independent organic radicals containing fluorine, F, and may be monomeric or polymeric. In certain embodiments, R and R″ may comprise organic monomeric radicals having a total number of repeating units or atoms in a range between 1 and 30, such as a chain of carbon, C, atoms. The chain may have a length in a range between 6 carbon atoms and 18 carbon atoms. In certain embodiments, the chain may have a length in a range between 7 carbon atoms and 12 carbon atoms. The organic component of the phosphonic acid, R and R″, may be aliphatic, aromatic, or both aliphatic and aromatic. R and R″ may be an unsubstituted hydrocarbon or a substituted hydrocarbon. In certain embodiments, R′ may be hydrogen, H, a metal such as, for example, an alkali metal (e.g., potassium, K, or sodium, Na), or an alkyl having a chain of carbon, C, atoms that have a length in a range between 1 carbon atom and 4 carbon atoms, such as methyl or ethyl. In certain embodiments, at least a portion of R′ may be hydrogen, H.

Organophosphorous acids may include, for example, amino trimethylene phosphonic acid, aminobenzylphosphonic acid, 3-amino propyl phosphonic acid, O-aminophenyl phosphonic acid, 4-methoxyphenyl phosphonic acid, aminophenylphosphonic acid, aminophosphonobutyric acid, aminopropylphosphonic acid, benzhydrylphosphonic acid, benzylphosphonic acid, butylphosphonic acid, carboxyethylphosphonic acid, diphenylphosphinic acid, dodecylphosphonic acid, ethylidenediphosphonic acid, heptade cylphosphonic acid, methylbenzylphosphonic acid, naphthylmethylphosphonic acid, octadecylphosphonic acid, octylphosphonic acid, pentylphosphonic acid, phenylphosphinic acid, phenylphosphonic acid, bis-(perfluoroheptyl)phosphinic acid, perfluorohexyl phosphonic acid, styrenephosphonic acid, dodecyl bis-1,12-phosphonic acid, poly(hexafluoropropylene oxide)phosphonic acid, poly(ethylene glycol)phosphonic acid, and perfluorostyrenephosphonic acid. In addition to the monomeric organophosphorous acids noted above, oligomeric or polymeric organophosphorous acids, resulting from self-condensation of the respective monomeric acids, may be used.

In certain embodiments, the organo portion of the organophosphorous compound may include fluoride, such as, for example, a perfluoro group. Perfluorinated polymeric (including oligomeric) radicals may have an average molecular weight of less than 2000. The perfluorinated compound may exhibit the following chemical structure:

R_{f}—(CH₂)ₚ—Z, (4)

where R_{f} is a perfluorinated alkyl group or a perfluorinated alkylene ether group and Z is a phosphorous acid group or derivative. In certain embodiments, p is 3. In other embodiments, p is in a range between 2 and 4. In still other embodiments, p is in a range between 1 and 10. In still other embodiments, p is in a range between 0 and 20. The certain embodiments, the perfluoro group may be a perfluoroalkyl group that exhibit the following chemical structure:

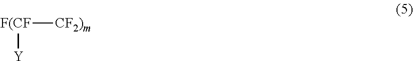

where Y is F or CₙF₂ₙ₊₁, m is in a range between 2 and 20, and n is in a range between 1 and 20. In other embodiments, the perfluoro group may be a perfluoralkylene ether group that exhibits the following chemical structure:

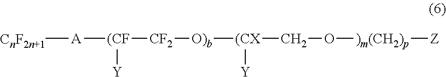

where C is carbon, F is fluorine, O is oxygen, H is hydrogen, X is hydrogen, H, or fluorine, F, A is an oxygen radical or a chemical bond, and Y is hydrogen, H, fluorine, F, CₙF₂ₙ₊₁, or CₙH₂ₙ₊₁. In certain embodiments, n is in a range between 1 and 2. In other embodiments, n is in a range between 1 and 6. In still other embodiments, n is in a range between 1 and 20. In certain embodiments, b is in a range between 5 and 12. In other embodiments, b is in a range between 2 and 50. In still other embodiments, b is at least 2 or more. In still other embodiments, b is at least 1 or more. In certain embodiments, m is in a range between 0 and 6. In other embodiments, m is in a range between 0 and 20. In still other embodiments, m is in a range between 0 and 50. Z may be a phosphorous acid group or a derivative.

In certain embodiments, the self-assembling monolayers may be fluoro-based or hydrocarbon-based self-assembling monolayers. In other embodiments, the self-assembling monolayers may be phosphate, silane, or thiol based that have fluoro or hydrocarbon functionality. In still other embodiments, the self-assembling monolayers may be Aculon® 620 solution manufactured by Aculon, Inc. of San Diego, Calif. In still other embodiments, the self-assembling monolayers may be Aculon® 620-AQ solution manufactured by Aculon, Inc. of San Diego, Calif. In still other embodiments, the self-assembling monolayers may be Aculon® 621 solution also manufactured by Aculon, Inc. of San Diego, Calif. One of ordinary skill in the art will recognize that other suitable self-assembling monolayers may be used in accordance with one or more embodiments of the present invention.

The self-assembling monolayers are reactive and spontaneously self-organize when they come into contact with the exposed portions of the conductive pattern. As such, the self-assembling monolayers form a self-assembled monolayer of molecular thickness over the exposed portions of the conductive pattern only. In this way, the self-assembled monolayer passivates the underlying metal, metal alloy, or metal oxides of the conductive pattern with a very thin coating that does not negatively affect the functionality of the conductive pattern. The self-assembled monolayer reduces or eliminates degradation that occurs as a result of, for example, electro-migration, exposure, and/or corrosion. Thus, the passivated conductive pattern resists degradation and the usable life and reliability of the conductive pattern may be extended.

In step 820, the substrate may be cleaned. In certain embodiments, the entire substrate, including the exposed portions of the conductive pattern may be cleaned. In other embodiments, only the exposed portions of the conductive pattern may be cleaned. In certain embodiments, such as, for example, those that utilize Aculon® 620 or Aculon® 620-AQ solution, the substrate may be cleaned with deionized water. In other embodiments, such as, for example, those that utilize Aculon® 621 solution, the substrate may be cleaned with isopropyl alcohol. One of ordinary skill in the art will recognize that other cleaning agents may be used so long as they remove undesired material and do not negatively affect the substrate or the self-assembled monolayer-covered portion of the conductive pattern.

Advantages of one or more embodiments of the present invention may include one or more of the following:

In one or more embodiments of the present invention, a method of passivating a conductive pattern with self-assembling monolayers provides a thin protective layer that has a thickness of a single molecular layer.

In one or more embodiments of the present invention, a method of passivating a conductive pattern with self-assembling monolayers may use fluoro-based or hydrocarbon-based self-assembling monolayers. In other embodiments, the self-assembling monolayers may be phosphate, silane, or thiol based that have fluoro or hydrocarbon functionality.

In one or more embodiments of the present invention, a method of passivating a conductive pattern with self-assembling monolayers may use reactive self-assembling monolayers that achieve greater than 90 percent self-organization of the surface area of the conductive pattern.

In one or more embodiments of the present invention, a method of passivating a conductive pattern with self-assembling monolayers may use reactive self-assembling monolayers that only bond to metal, metal alloy, or metal oxides of the conductive pattern and do not bond to, or otherwise cover, the underlying polymer or substrate material. Advantageously, the application process may be simplified because the entire substrate, including exposed portions of the conductive pattern, may be covered with self-assembling monolayers during the application process.

In one or more embodiments of the present invention, a method of passivating a conductive pattern with self-assembling monolayers may use reactive self-assembling monolayers that only bond to metal, metal alloy, or metal oxides of the conductive pattern and do not bond to, or otherwise cover, the underlying polymer or substrate material. Advantageously, the underlying polymer or substrate material may easily bond to other devices or structures as part of an assembly.

In one or more embodiments of the present invention, a method of passivating a conductive pattern with self-assembling monolayers may use reactive self-assembling monolayers instead of other more expensive, difficult to apply, and/or reflective passivation coatings, such as, for example, nickel or nickel alloy. In applications that use copper conductors as part of the conductive pattern, the use of self-assembling monolayers instead of reflective passivation coatings may reduce or eliminate the reflectivity that typically occurs because of the passivation coating, saves process time, and reduces manufacturing costs.

In one or more embodiments of the present invention, a method of passivating a conductive pattern with self-assembling monolayers reduces or eliminates electro-migration in the conductive pattern. This reduction or elimination of electro-migration may be advantageous in embodiments that use electro-migration prone metals as part of the conductive pattern, such as, for example, silver.

In one or more embodiments of the present invention, a method of passivating a conductive pattern with self-assembling monolayers prevents or reduces degradation of the conductive pattern. The potential causes of degradation include, for example, airborne, solution-based, or liquid-based exposure to the environment or corrosive agents such as soft drinks, coffee, oils, bodily fluids, acids, caustics, atmospheric pollutants, environmental pollutants, salt water, or water with contaminants such as salts, minerals, or ions.

In one or more embodiments of the present invention, a method of passivating a conductive pattern with self-assembling monolayers prevents or reduces corrosion of the conductive pattern. Corrosion typically renders part of the conductive pattern black, blue, or green. Corroded portions are more visually apparent to an end user of a touch screen. Because the method of passivating a conductive pattern with self-assembled monolayers prevents or reduces corrosion, the conductive pattern is not discolored and its visual appearance is not enhanced by corrosion.

In one or more embodiments of the present invention, a method of passivating a conductive pattern with self-assembling monolayers does not reduce conductivity in a significant amount.

In one or more embodiments of the present invention, a method of passivating a conductive pattern with self-assembling monolayers does not increase resitivity in a significant amount.

In one or more embodiments of the present invention, a method of passivating a conductive pattern with self-assembling monolayers extends the usable life of the conductive pattern.

In one or more embodiments of the present invention, a method of passivating a conductive pattern with self-assembling monolayers improves the reliability of the conductive pattern.

In one or more embodiments of the present invention, a method of passivating a conductive pattern with self-assembling monolayers is inexpensive and does not substantively increase manufacturing cost of the conductive pattern. In certain embodiments, the use of self-assembling monolayers reduces or eliminates other aspects of the conductive pattern manufacturing process and, as a consequence, provides a net cost savings over traditional manufacturing methods.

In one or more embodiments of the present invention, a method of passivating a conductive pattern with self-assembling monolayers may be applied at ambient temperature, humidity, and atmospheric pressure. Expensive equipment typically used in the application of a conventional passivation layer, such as vacuum equipment and adhesive film lamination, are not required in the application of self-assembling monolayers.

In one or more embodiments of the present invention, a method of passivating a conductive pattern with self-assembling monolayers is compatible with flexographic printing processes.

In one or more embodiments of the present invention, a method of passivating a conductive pattern with self-assembling monolayers is compatible with other conductive pattern fabrication processes.

In one or more embodiments of the present invention, a conductive pattern passivated with self-assembling monolayers may pass an accelerated stress test such as exposure to 85% humidity and 85 degrees Celsius test for at least 5 days.

In one or more embodiments of the present invention, a conductive pattern passivated with self-assembling monolayers may pass an accelerated stress test such as exposure to 90% relative humidity and 60 degrees Celsius test for at least 10 days.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method comprising:
disposing a conductive pattern on a substrate;
applying self-assembling monolayers to exposed portions of the conductive pattern, wherein the self-assembling monolayers self-organize and bond to the exposed portions of the conductive pattern; and
cleaning the substrate.

2. The method of claim 1, wherein applying self-assembling monolayers comprises spray coating a solution of self-assembling monolayers on the exposed portions of the conductive pattern.

3. The method of claim 1, wherein applying self-assembling monolayers comprises dip coating a solution of self-assembling monolayers on the exposed portions of the conductive pattern.

4. The method of claim 1, wherein applying self-assembling monolayers comprises roller coating a solution of self-assembling monolayers on the exposed portions of the conductive pattern.

5. The method of claim 1, wherein applying self-assembling monolayers comprises aerosol fogging the self-assembling monolayers on the exposed portions of the conductive pattern.

6. The method of claim 1, wherein the self-assembling monolayers comprise fluoro-based self-assembling monolayers.

7. The method of claim 1, wherein the self-assembling monolayers comprise hydrocarbon-based self-assembling monolayers.

8. The method of claim 1, wherein the self-assembling monolayers comprise Aculon® 620 solution.

9. The method of claim 1, wherein cleaning the substrate comprises rinsing the substrate with deionized water.

10. The method of claim 1, wherein the self-assembling monolayers comprise Aculon® 621 solution.

11. The method of claim 1, wherein cleaning the substrate comprises rinsing the substrate with isopropyl alcohol.

12. The method of claim 1, wherein the conductive pattern comprises a plurality of parallel conductive lines oriented in a first direction and a plurality of parallel conductive lines oriented in a second direction.

13. The method of claim 1, wherein the substrate is transparent.

14. The method of claim 13, wherein the transparent substrate comprises polyethylene terephthalate.

15. The method of claim 1, wherein the self-assembling monolayers do not self-organize or bond to exposed portions of the substrate.

16. The method of claim 1, wherein the conductive pattern comprises copper.

17. The method of claim 1, wherein the conductive pattern comprises a copper alloy.

18. The method of claim 1, wherein the self-assembling monolayers are applied at ambient temperature.

19. The method of claim 1, wherein the self-assembling monolayers are applied at ambient humidity.

20. The method of claim 1, wherein the self-assembling monolayers are applied at ambient pressure.

21. The method of claim 1, wherein the self-assembling monolayers self-organized and bonded to the exposed portions of the conductive pattern form a self-assembled monolayers passivation layer that has a thickness of approximately one molecule.
